(19) United States
(12) Patent Application Publication
(10) Pub. No.: US 2026/0212880 A1
(43) Pub. Date: Jul. 23, 2026

(54) METHOD FOR DETECTING LIVING BEINGS IN A PASSENGER COMPARTMENT, AND VEHICLE

(71) Applicant: MERCEDES-BENZ GROUP AG, Stuttgart (DE)

(72) Inventor: Rene WIRTZ, Stuttgart (DE)

(21) Appl. No.: 19/157,778

(22) PCT Filed: Jan. 23, 2024
(86) PCT No.: PCT/EP2024/051523

§ 371 Date: Aug. 19, 2025

(30) Foreign Application Priority Data
Feb. 20, 2023 (DE) 10 2023 000 575.4

(51) Int. Cl. G10L 25/51; B60Q 1/50; B60Q 5/00; G10L 25/30; H04R 1/40; H04R 3/00

(52) U.S. Cl. CPC G10L 25/51; B60Q 1/544; B60Q 5/005; G10L 25/30; H04R 1/406; H04R 3/005; H04R 2499/13

(57) ABSTRACT

Living beings in a passenger compartment are detected using a neural-acoustic fields (NAF) database. A computing unit stores an NAF database having a plurality of neural-acoustic fields of the passenger compartment for different presence scenarios. Background noise in the passenger compartment is recorded by microphones at least when closing the vehicle doors. The computing unit compares the recorded background noise with the neural-acoustic fields stored in the NAF database and determines at least one neural-acoustic field having the highest match with the recorded background noise. The presence of living beings in the passenger compartment determined using the at least one neural-acoustic field having the highest match.

### BACKGROUND AND SUMMARY OF THE INVENTION

Exemplary embodiments of the invention relate to a method for detecting living beings in a passenger compartment, as well as to a vehicle.

It can happen in everyday life that children or animals are forgotten in the passenger compartment or are intentionally left there. For example, a dog owner would like to quickly go into a shop, but does not want to take their dog with them. This means that life-threatening situations may arise, in particular in the event of strong sun rays in summer and cold temperatures in winter, as the passenger compartment can heat up and respectively cool down significantly, which puts a corresponding child or pet at risk of overheating or getting hypothermia. Thus, the need arises for means and methods to warn vehicle users about children of animals left in the vehicle.

For example, DE 10 2019 212 412 A1 discloses a monitoring device and a method for monitoring a living being in the interior of a vehicle. The document describes the monitoring of the passenger compartment by means of optical detecting means, such as cameras, acoustic detecting means, such as microphones, and by means of temperature sensors. Data generated by the cameras, microphones and temperature sensors is evaluated by a computing unit using artificial intelligence. The computing unit carries out a classification for determining the respective presence situation. To determine whether living beings are present in the passenger compartment, the data from further sensors, such as seat occupancy sensors, movement sensors and/or seatbelt sensors, can also be taken into consideration. By using cameras and microphones and due to the presence of display devices and loudspeakers in the vehicle, a baby monitor function can be provided. Video content and audio content recorded in the passenger compartment can therefore be transmitted to the smartphone of the vehicle user and audio and video content recorded by the smartphone can be transmitted back into the vehicle. This allows the vehicle user to calm down children present in the passenger compartment. Due to the requirement to provide different types of sensors, the corresponding monitoring device is however comparatively complex and expensive.

Thus, it would be desirable to provide a function for detecting the presence of living beings in passenger compartments using cost-effective means that have a simple construction.

The detection of distance information via sound is well known. For this purpose, different devices exist, such as echo sounders, sonar or ultrasound systems, such as those used to create a parking aid, also colloquially known as a “parking sensor”.

The spatial modelling of the acoustic characteristics of the surroundings is also the subject matter of current research. Andrew Luo et al. describe methods and means with which it is possible to receive structural information about a scene purely via acoustics. For this purpose, researchers present the concept of neural-acoustic fields (NAF), referred to as Neural Acoustic Field in the work. Such a neural-acoustic field contains geometric information describing the structure of the surveyed surroundings. To generate such a neural-acoustic field, sound measurements are carried out in surroundings to be mapped, for example a room or an apartment. These sound measurements require a plurality of individual measurements be carried out. A sound source and a sound receiver is arbitrarily placed in the surroundings to be investigated for each individual measurement, and a sound impulse is output via the sound source which is detected by the sound receiver. The measured impulse response is transformed by using a short-time Fourier transform into a spectrogram. The thus created spectrograms are then processed by an artificial neural network, which determines the requested neural-acoustic field as output variables. For details see: Learning Neural Acoustic Fields, Andrew Luo, Yilun Du, Michael J. Tarr, Joshua B. Tenenbaum, Antonio Torralba, Chuang Gan, https://doi.org/10.48550/arXiv.2204.00628.

Exemplary embodiments of the present invention are directed to an improved method for detecting living beings in a passenger compartment, which also functions reliably with simpler hardware.

A generic method for detecting living beings in a passenger compartment, wherein the passenger compartment is acoustically monitored by at least two microphones and a computing unit evaluates signals created by the microphones using artificial intelligence, is further developed according to the invention by the following method steps:
a) implementing an NAF database in a computing unit, wherein the NAF database comprises a plurality of neural-acoustic fields of the passenger compartment for different presence scenarios, and wherein the NAF database is created by an initial measurement campaign in a representative passenger compartment by recording in each case at least one neural-acoustic field while varying at least dummy type, number of dummies and dummy sitting position;
b) recording background noise in the passenger compartment by means of the microphones at least when closing the vehicle doors;
c) comparing, by means of the computing unit, the recorded background noise with the neural-acoustic fields stored in the NAF database;
d) determining, by means of the computing unit, at least one neural-acoustic field which has the highest match with the recorded background noise; and
e) establishing, by means of the computing unit, the presence of living beings in the passenger compartment, corresponding to the respective presence scenario underlying the neural-acoustic field determined in step d).

Using the method according to the invention, acoustic monitoring of the vehicle interior is made possible in a completely novel manner, which reliably allows the presence of living beings in the passenger compartment to be detected using simple means. The neural-acoustic fields represent acoustic mapping of the passenger compartment. In order to detect living beings in the passenger compartment, corresponding maps are created for all possible considered presence scenarios. These measurement campaigns are carried out, for example, by the vehicle manufacturer.

Dummies, such as crash dummies, puppets, water-filled canisters, or similar serve to simulate the presence of living beings. Adults, children, and animals can be abstracted by using different dummy types, i.e., for example, larger or smaller dummies. A dummy can also be covered with a blanket, feather, or hairs, in order to simulate a coat or plumage. The number of dummies varies between zero and the maximum number of seats in the passenger compartment. The dummies are arranged in all possible seat positions. Thus, it is ensured that all possible presence scenarios are covered by the neural-acoustic fields.

If the vehicle is later used and an adult driver is located on the driving seat and a child and a dog are located in the rear of the vehicle, this results in corresponding acoustics in the passenger compartment. These acoustics are mapped by a corresponding neural-acoustic field. In this case there is a correlation between a neural-acoustic field from the initial measurement campaign and the following presence scenario: a large dummy on the driver's seat and a small and a particularly small dummy respectively in the rear of the vehicle on the left and right seat. Accordingly, information about the type of dummy, the number of dummies, and the dummy seat position on which the respective presence scenario is based is linked in the NAF database to the respective neural-acoustic field.

In order to enable the highest possible match between the measured background noise and a neural-acoustic field stored in the NAF database, the corresponding measurement campaigns are carried out individually for different representative vehicles. In this case, “representative” is understood to mean that the vehicle, which has been used to carry out the initial measurement campaign, at least corresponds to the same series as the vehicle in which the method is ultimately used. This ensures that the geometry of the passenger compartment is substantially the same, which is significant for the acoustic characteristics of the passenger compartment.

The initial measurement campaign can be designed as comprehensively as desired. Further influencing factors, such as the seat setting, i.e., in particular a backrest angle, a position or travel position of an entire vehicle seat, the presence of child seats and/or further objects transported in the vehicle can therefore be investigated. In each case, corresponding neural-acoustic fields, along with the dummy type, the number of dummies and dummy seat position, can be recorded for the different seat settings, as well as, for example, for a handbag placed in the rear of the vehicle, a laptop bag placed on the passenger seat and similar.

In this case, at least one neural-acoustic field is recorded in the initial measurement campaign for each parameter combination. Preferably, however, several neural-acoustic fields can also be recorded, whereby measurement inaccuracies or errors resulting from statistical events can be reduced. In particular, several neural-acoustic fields for different sound source configurations are recorded in the case of an identical presence scenario. For this purpose, in particular the type of sound source and/or the sound source position is varied in relation to the passenger compartment.

Therefore, when the vehicle is used later, it is particularly practical when the closing of the vehicle doors is used as a sound source for detecting the background noise in the passenger compartment. Closing the vehicle doors is particularly suitable as a sound source, as a short and concise sound impulse is generated in the process. Additionally, it is not necessary to output an artificial excitation signal in the passenger compartment. In this context “when closing” means that the sound signals relevant to the processing are analyzed within a time period from closing the vehicle doors until shortly thereafter. This time period can be in the magnitude of a few seconds or even milliseconds. In this case, the microphones have to be activated at least during the recording period. The microphones can also be activated before the actual recording period and can be deactivated some time after the recording period has ended. For example, the microphones can be activated when opening of the vehicle doors is sensorially detected. Opening and closing of vehicle doors usually happens when a vehicle is stationary. In this case, it is the moment in particular when vehicle occupants enter or leave the vehicle. This is a relevant moment to determine the presence of living beings in the passenger compartment. In general, however, it is also possible that the microphones are also activated again during the journey and audio signals are recorded. This is discussed in more detail in the following.

Due to the provision of several microphones in the passenger compartment, several neural-acoustic fields can be recorded simultaneously in the case of one single acoustic signal source. The installation position of the corresponding microphones between a representative vehicle and the vehicle in which the method is carried out, matches accordingly. Typically, vehicles possess several such passenger compartment microphones, for example to provide a hands-free system for a telephone or for detecting voice commands for a voice assistant. In order to be able to detect the voice of different vehicle occupants as best as possible, typically microphones are provided at different installation positions.

In step d), the computing unit determines at least one neural-acoustic field that best matches the recorded background noise. The comparison of background noise described in step c) can therefore in particular provide that a neural-acoustic field itself is generated from the recorded background noise and this is compared with the NAF database. In this case, such a field particularly stands out from the entirety of the neural-acoustic fields stored in the NAF database, so it is clear which presence scenario there is, i.e., how many living beings are in the passenger compartment, on which seat positions they are, and what kind of living being they are, i.e., for example, an adult, a child or an animal.

By processing the acoustic signals, the computing unit can also determine, if necessary, which animal it is, for example, by recognizing a bark, meow, chirp, or similar.

However, cases can also occur in which several neural-acoustic fields from the NAF database have similarities to the recorded background noise. The computing unit then compares the information linked to the respective presence scenarios. For example, exactly the neural-acoustic fields can have a high match in case where two living beings are present in the passenger compartment. However, the respective seat position varies. In such a case, the number of living beings present in the passenger compartment can be determined by means of the method according to the invention, but not the exact seating position.

However, with the aid of the method according to the invention, it is at least possible to distinguish whether at least one living being is present in the passenger compartment or not.

An advantageous further development of the method according to the invention provides that slamming a vehicle door serves as an acoustic signal source in the initial measurement campaign for creating the NAF database, wherein in particular neural-acoustic fields are also logged while varying the slammed vehicle door. Since, at least when the vehicle is stationary, when the vehicle doors are opened and closed, the method according to the invention is carried out for determining the presence of living beings in the passenger compartment and therefore the slamming of the vehicle door(s) serves as (a) sound source(s), the slamming of the vehicle doors also serves in a particularly advantageous manner as a sound source for creating the NAF database in the initial measurement campaign. Thus, the neural-acoustic fields created in the initial measurement campaign are based on the same sound source that is also used later when carrying out the method in the vehicle. This means that the degree of matching between the background noise recorded in the passenger compartment (i.e., in particular a neural-acoustic field derived from the background noise) and the neural-acoustic fields stored in the NAF database can be increased.

According to a further advantageous embodiment of the method, the computing unit determines which vehicle door has been closed taking into consideration a door closing sensor when closing the vehicle door. Depending on which vehicle door is closed and thus serves as a sound source, this has an influence on the corresponding neural-acoustic field due to the changed position of the sound source. Thus, individual neural-acoustic fields are recorded for each possible combination of slammed vehicle doors. In this case, a single vehicle door can be slammed or else several vehicle doors can be slammed simultaneously or in quick succession. This is taken into account accordingly in the initial measurement campaign. Taking into account the data transmitted by a door closing sensor, the computing unit can therefore detect exactly which vehicle door is slammed. The computing unit can then take this information into account when determining the match between background noise recorded in the passenger compartment and neural-acoustic fields stored in the NAF database. The computing unit only selects those neural-acoustic fields from the NAF database which are eligible for agreement and in the case of which the corresponding vehicle door served as a sound source.

A further advantageous embodiment of the method according to the invention also provides that different measurement campaigns are carried out for creating the NAF database depending on the vehicle configuration. Alongside the influencing variables already explained, the vehicle configuration also affects the respective neural-acoustic fields. For example, if a specific vehicle seat type is installed, such as a sporty seat, this has a specific material composition such as leather for example, or if other specialized components are arranged in the passenger compartment, such as moldings made from burr wood, this can influence the soundscape in the passenger compartment. For example, sound is reflected by a smooth surface differently in comparison to being reflected by a rough surface, such as velvet or textured plastic.

The vehicle manufacturer can carry out corresponding measurement campaigns not only for different series, but also for different vehicle configurations of each series. Then, all thus-generated neural-acoustic fields can be implemented in the computing unit of the vehicle, or only the ones which were recorded in the representative passenger compartment with the corresponding vehicle configuration. This means that memory space in the computing unit can be saved. However, if the vehicle configuration changes over the vehicle service life, then a missing NAF database or missing neural-acoustic fields subsequently need to be introduced into the computing unit. For example, this can take place by means of an update, preferably by a wireless “over-the-air” update.

According to a further advantageous embodiment of the method according to the invention, the computing unit carries out a measurement campaign for expanding the NAF database in the operational phase of the vehicle, wherein information describing a current presence scenario is pro-actively requested by a user. In other words, the computing unit is capable of learning. The user of the vehicle can record new neural-acoustic fields in the operational phase, i.e., the time period during the phase of life of the vehicle in which the vehicle is used by the user. For this purpose, dummies are no longer used; rather the actual living beings typically travelling in the vehicle, such as family members or pets. This means that the degree of matching between the background noise that can be recorded in the vehicle and the neural-acoustic fields stored in the NAF database can be further increased. In order for the computing unit to be informed of the corresponding presence scenario, this information has to be specified manually for the computing unit. For this purpose, the user can use a suitable human-machine interface, for example a touch-sensitive display device.

A further advantageous embodiment of the method according to the invention also provides that the method steps b) to e) are carried again out at a later point in time after the vehicle door has been closed, with an acoustic excitation signal being output via at least one loudspeaker arranged in the vehicle. As already explained, by means of the method according to the invention, the presence of living beings in the passenger compartment can not only take place when slamming the doors, but also at a later point in time, for example during the journey. This means that the formerly determined presence of living beings, in particular the number, living being type and seat positioning, can be verified. As vehicle doors should be opened and closed during the journey, preferably another sound source is used. For this purpose, the loudspeakers of the vehicle can be used, in particular audio signals are output via loudspeakers arranged at different points in the passenger compartment. Particularly preferably, here as well, the excitation signals match the excitation signals used in the initial measurement campaign.

For example, when the vehicle is at a standstill, a pet can be brought into the passenger compartment through an open door window. Accordingly, the correct number of living beings can also be determined during the journey.

Preferably, the acoustic excitation signal output via the at least one loudspeaker exclusively comprises frequencies in the ultrasound frequency band and/or in the infrasound frequency band. This has the advantage that corresponding excitation signals cannot be perceived by the vehicle occupants. Thus, it is possible to carry out the method according to the invention without the vehicle occupants noticing. This means that in particular user comfort is improved.

A further advantageous embodiment of the method according to the invention also provides that in method step d), the computing unit similarly uses artificial intelligence to determine the neural-acoustic field that matches the background noise. Tried and tested practices and methods from artificial intelligence, such as artificial neural networks, in particular deep artificial neural networks, can be used for this purpose. This enables even more reliable matches between recorded background noise and neural-acoustic fields stored in the NAF database to be determined. In particular, a corresponding machine learning model compares a neural-acoustic field derived from the recorded background noise with the NAF database.

According to a further advantageous embodiment of the method according to the invention, the computing unit only causes an emergency action to be performed when a living being has been detected in the passenger compartment and then the vehicle receives a door locking signal. Different actions can be carried out as an emergency action, such as activating illumination devices, for example the front headlights, rear lights, an indicator, and similar, and outputting acoustic warning signals, for example via the horn of the vehicle. Thus, passers-by in the surroundings of the vehicle can be warned. Similarly, warning messages can be transmitted via a wireless communication link, for example to a mobile end device of the vehicle owner, or also to a rescue service. The computing unit can also control a vehicle function and for instance can open a window by actuating electrical window controls or activate the air-conditioning system of the vehicle. This means that overheating in the summer can be prevented, for example.

By only carrying out the emergency action when the vehicle is locked, corresponding emergency actions are prevented from being initiated unnecessarily. If the vehicle doors are unlocked, this typically means that a person driving the vehicle is present or close-by. Thus, there is usually no danger to children and pets in the passenger compartment. In contrast, if the vehicle is locked, the person driving the vehicle also moves away, and the danger to children and/or animals left in the vehicle increases accordingly. This is taken into account.

In a vehicle, comprising at least two microphones and a computing unit, the microphones and the computing unit are configured according to the invention to carry out a method described above. The vehicle may be any vehicle, such as a car, lorry, van, bus, or similar. The microphones are arranged at different positions in the passenger compartment. This enables different neural-acoustic fields to be recorded in a particularly comprehensive and sophisticated manner. The computing unit may be a central on-board computer, a control device of a vehicle subsystem, a telematics unit, or similar. Different steps to be carried out by the computing unit can also be distributed to several computing units physically separated from each other. The one or more computing units comprise computer-readable storage media, on which in each case a computer program product is stored, the execution of which by a processor causes the method steps explained in conjunction with the method according to the invention to be implemented in the vehicle.

Further advantageous embodiments of the method according to the invention for detecting living beings in a passenger compartment and of the vehicle also result from the exemplary embodiments which are described in more detail below with reference to the figures.

### BRIEF DESCRIPTION OF THE DRAWING FIGURES

Here the figures show:

FIG. 1 a schematized representation of a neural-acoustic field of an apartment; and

FIG. 2 a schematized representation of the sequence of a method according to the invention for determining the presence of living beings in a passenger compartment based on the creation of neural-acoustic fields.

### DETAILED DESCRIPTION

A neural-acoustic field NAF corresponds to a representation of the acoustic characteristics of surveyed surroundings. Andrew Luo et al. describe in their paper Learning Neural Acoustic Fields, https://doi.org/10.48550/arXiv.2204.00628, how such neural-acoustic fields NAF can be created. The structures, i.e., the geometry of the analyzed space, can be estimated by means of such a neural-acoustic field NAF. Thus, geometric information can be derived purely based on acoustic analyses.

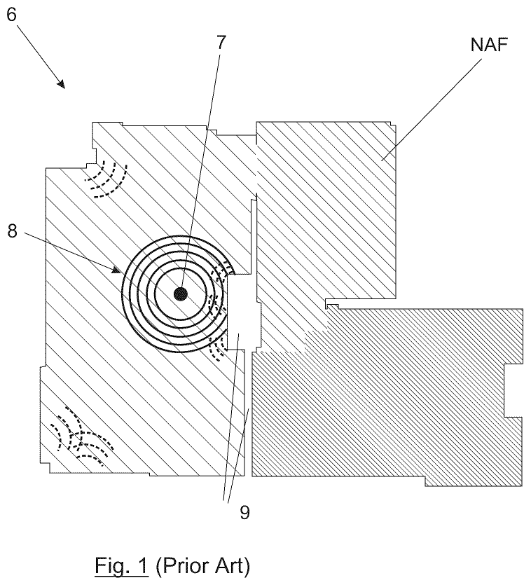

FIG. 1 shows such a neural-acoustic field NAF of an apartment 6. A sound source 7 is represented, which has been placed at any location inside the surroundings, here said apartment 6, to be analyzed. With the aid of acoustic detecting means, for example a (optionally stereo-) microphone, an acoustic signal output by the sound source 7 is detected. Sound waves 8 propagating in the surroundings to be measured are also represented. Continuous lines represent sound originating from the sound source 7 and dashed lines represent echoes reflected back from the surroundings. While varying the location of the sound source 7 and detecting means (not shown in more detail), the surroundings to be analyzed are mapped. Impulse responses recorded by the acoustic detecting means are subjected to a short-time Fourier transform and a spectrogram is generated therefrom. The spectrograms of a plurality of individual measurements are then provided as input variables for a machine learning model in the form of an artificial neural network. The artificial neural network then determines the neural-acoustic field NAF represented in FIG. 1. Such a neural-acoustic field NAF shows the volume or the noise level depending on the position of the used sound source 7 as a local distribution of the analyzed surroundings. In FIG. 1, the volume is represented as a grey scale, wherein light grey corresponds to loud sounds and dark grey or black correspond to quiet sounds. Holes 9 which correspond to walls or objects such as furniture can clearly be seen.

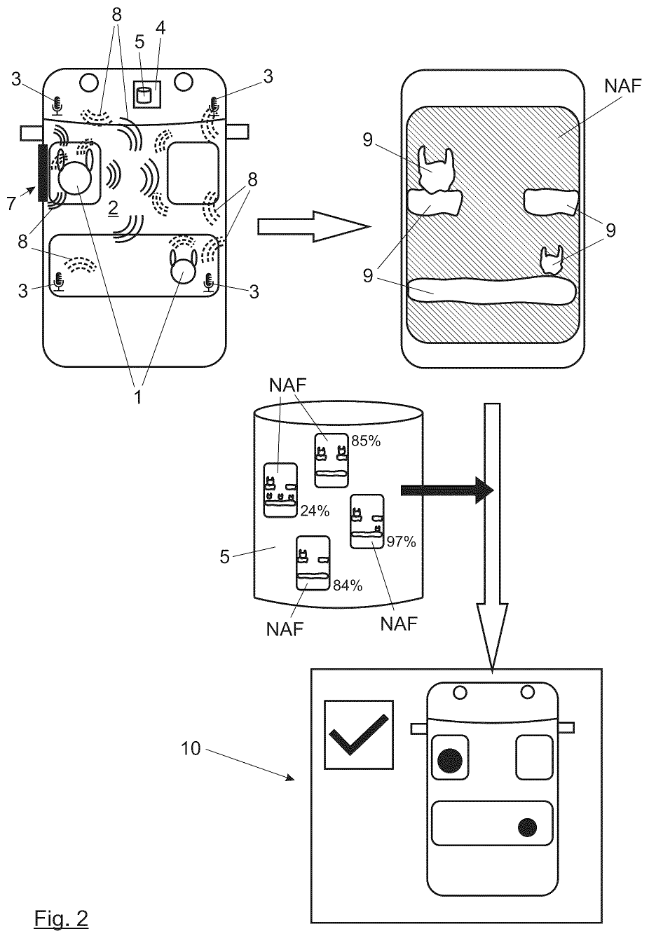

This technique described in the paper published by Andrew Lou et al. can be used for detecting living beings in passenger compartments. This is possible by means of a method according to the invention, the method sequence of which is represented schematically in FIG. 2.

Initially, in a measurement campaign, a passenger compartment 2 of a vehicle has to be surveyed accordingly. For this purpose, dummies in different designs are placed at different seat positions in different numbers in the passenger compartment 2 and different sound excitation signals are output for measuring the background noise in the passenger compartment 2. Then a plurality of neural-acoustic fields NAF are generated for different presence scenarios and are aggregated in an NAF database 5. This NAF database 5 is then entered into a computing unit 4 of the vehicle, which is to carry out the method according to the invention.

When the vehicle is later used, the background noise is recorded when closing the vehicle doors by means of several microphones 3, here, for example, four microphones 3 arranged distributed in the passenger compartment 2, in order to determine the presence of living beings in the passenger compartment 2. In the exemplary embodiment shown in FIG. 2, the living beings 1 in the passenger compartment 2 are an adult person driving the vehicle located on the driver's seat of the vehicle and a child located on a right back seat. The propagation of the sound waves 8 in the passenger compartment 2 is influenced by the presence of the living beings 1 when closing the vehicle door. The vehicle door therefore serves as a sound source 7.

The computing unit 4 can derive an individual neural-acoustic field NAF or an averaged neural-acoustic field NAF for each microphone 3 from the background noise thus recorded. This is represented at the top right in FIG. 2, and shows corresponding holes 9 at the points at which structures are located in the passenger compartment 2. A section from the neural-acoustic field NAF is represented at a specific geodetic height. This geodetic height corresponds in particular to the height at which the respective microphones 3 are mounted in the passenger compartment 2. It is particularly advantageous if several microphones 3 are arranged at different geodetic heights in the passenger compartment 2, so that sections can be generated at different height positions. Alongside the living beings 1, holes 9 are represented for the corresponding backrests of the vehicle seats.

This process sequence represented in FIG. 2 can be explicitly or implicitly implemented. An explicit sequence provides that the neural-acoustic field NAF derived from the background noise is geometrically compared to the neural-acoustic fields NAF stored in the NAF database 5. For example, a correlation between overlapping line curves is determined mathematically. In contrast, an implicit sequence provides that the respective neural-acoustic fields NAF are only analyzed for “similarity”. For this purpose, in particular artificial intelligence can compare the respective data structures of the neural-acoustic fields NAF to each other. Such a comparison by means of a corresponding machine learning model operates as a black box.

In order to compare the background noise or the neural-acoustic fields NAF derived from the background noise with the NAF database 5, the computing unit 4 checks which neural-acoustic field NAF stored in the NAF database 5 has the highest match. For this purpose, the computing unit 4 reads out the corresponding NAF database 5. Different match probabilities are represented by way of example. At least the neural-acoustic field NAF with the highest match is selected as being a match in a result 10.

Accordingly, the computing unit 4 deduces that the presence scenario of the respective neural-acoustic field NAF present when recording in the initial measurement campaign also currently applies to the vehicle. It can at least be determined whether a living being 1 is present in the passenger compartment 2 or not. The more clearly a specific neural-acoustic field NAF from the NAF database 5 matches the neural-acoustic field NAF derived for the background noise, the more information can be derived, in particular the number of living beings 1, the type of living being 1, i.e., adult, child, animal or similar, and on which seat the living being 1 is located.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-10. (canceled)

11. A method for detecting living beings in a passenger compartment of a vehicle, the method comprising:
a) storing a neural-acoustic fields (NAF) database in a computing unit of the vehicle, wherein the NAF database includes a plurality of NAF of the passenger compartment for different presence scenarios, and wherein the NAF database is created by an initial measurement campaign in a representative passenger compartment by recording, in each case, at least one NAF while varying at least dummy type, number of dummies and dummy sitting position;
b) recording, by at least two microphones of the vehicle, background noise in the passenger compartment at least when closing at least one door of the vehicle;
c) comparing, by the computing unit, the recorded background noise with the NAF stored in the NAF database;
d) determining, by the computing unit, at least one NAF in the NAF database having a highest match with the recorded background noise; and
e) establishing, by the computing unit, presence of living beings in the passenger compartment, corresponding to a respective presence scenario underlying the NAF determined in step d).

12. The method of claim 11, wherein slamming of the at least one door of the vehicle serves as an acoustic signal source in the initial measurement campaign for creating the NAF database.

13. The method of claim 11, further comprising:
determining, by the computing unit and accounting for a door closing sensor signal, which doors of the vehicle has been closed.

14. The method of claim 11, wherein different initial measurement campaigns are performed to create the NAF database depending on different configurations of the vehicle.

15. The method of claim 11, further comprising:
performing, by the computing unit, a measurement campaign to expand the NAF database during an operational phase of the vehicle, wherein information describing a current presence scenario is proactively requested by a user.

16. The method of claim 11, wherein method steps b) to e) are performed again at a later point in time after the at least one door of the vehicle is closed with an acoustic excitation signal being output via at least one loudspeaker arranged in the vehicle.

17. The method of claim 16, wherein the acoustic excitation signal output via the at least one loudspeaker exclusively comprises frequencies in an ultrasound frequency band or in an infrasound frequency band.

18. The method of claim 11, wherein, in method step d), the computing unit uses artificial intelligence to determine the NAF having the highest match with the recorded background noise.

19. The method of claim 11, wherein the computing unit only causes an emergency action to be performed when a living being is detected in the passenger compartment and the vehicle receives a door locking signal.

20. A vehicle comprising:
a passenger compartment;
at least two microphones; and
a computing unit coupled to the at least two microphones,
wherein the computing unit of the vehicle stores a neural-acoustic fields (NAF) database including a plurality of NAF of the passenger compartment for different presence scenarios, and wherein the NAF database is created by an initial measurement campaign in a representative passenger compartment by recording, in each case, at least one NAF while varying at least dummy type, number of dummies and dummy sitting position,
wherein the at least two microphones of the vehicle are configured to record background noise in the passenger compartment at least when closing at least one door of the vehicle,
wherein the computing unit is configured to compare the recorded background noise with the NAF stored in the NAF database,
wherein the computing unit is configured to determine at least one NAF in the NAF database having a highest match with the recorded background noise, and
wherein the computing unit is configured to establish presence of living beings in the passenger compartment (2) corresponding to a respective presence scenario underlying the NAF having the highest match.
